(19) United States
(12) Patent Application Publication
(10) Pub. No.: US 2006/0272674 A1
(43) Pub. Date: Dec. 7, 2006

(54) Method and apparatus for cleaning and surface conditioning objects using plasma

(75) Inventor: Peter Frank Kurunczi, Somerville, MA (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Cerionx, Inc.

(21) Appl. No.: 11/143,083

(22) Filed: Jun. 2, 2005

(51) Int. Cl. B08B 6/00; C23F 1/00

(52) U.S. Cl. 134/1.1; 156/345.43

(57) ABSTRACT

An apparatus and method for cleaning objects using plasma are disclosed. The apparatus provides a plurality of elongated dielectric barrier members arranged adjacent each other; a first set of electrodes arranged to be coupled to a voltage source at a first voltage, each electrode of the first set contained within, and extending substantially along the length of, a first set of the elongated dielectric barrier members; and a second set of electrodes arranged to be coupled to a voltage source at a second voltage, each electrode of the second set contained within, and extending substantially along the length of, a second set of the elongated dielectric barrier members; whereby, when the first and second voltages are applied, dielectric barrier discharges are created to form plasma between adjacent elongated dielectric barrier members for cleaning at least a portion of the objects. The method provides a plurality of elongated dielectric barrier members having a first and second set of electrodes arranged therein; introducing the objects proximate the elongated dielectric barrier members; and generating a dielectric barrier discharge to form plasma between the elongated dielectric barrier members for cleaning at least a portion of each of the objects.

### CROSS-REFERENCE TO RELATED APPLICATIONS

This application is related to co-pending patent application entitled “Atmospheric Pressure Non-Thermal Plasma Device To Clean and Sterilize The Surfaces Of Probes, Cannulas, Pin Tools, Pipettes And Spray Heads”, filed Jun. 1, 2004, and assigned Ser. No. 10/858,272; co-pending patent application entitled “Method and Apparatus for Cleaning and Surface Conditioning Objects Using Non-Equilibrium Atmospheric Pressure Plasma”, filed Jan. 21, 2005, and assigned Ser. No. 11/040,222; and co-pending patent application entitled “Method and Apparatus for Cleaning and Surface Conditioning Objects With Plasma,” assigned Ser. No. 11/043,787, filed Jan. 26, 2005; all disclosures of which are commonly assigned with the present invention and are incorporated herein by reference in their entirety.

### BACKGROUND OF THE INVENTION

1. Field of the Invention

Embodiments of the present invention generally relate to a method and apparatus for cleaning and surface conditioning fluid handling devices and, in particular, to a method and apparatus for cleaning and surface conditioning portions of fluid handling devices using plasma generated from a power source having a center tapped transformer.

2. Description of the Related Art

In certain clinical, industrial and life science testing laboratories, extremely small quantities of fluids, for example, volumes between a drop (about 25 micro-liters) and a few nano-liters may need to be analyzed. Several known methods are employed to transfer these small amounts of liquid compounds from a source to a testing device. Generally, liquid is aspirated from a fluid holding device into a fluid handling device. The fluid handling device may include, but is not limited to, a probe, cannula, disposable pipette, pin tool or other similar component or plurality of such components (hereinafter collectively referred to as “probes”). The fluid handling device and its probes may move, manually, automatically or robotically, dispensing the aspirated liquid into another fluid holding device for testing purposes and the like.

Commonly, the probes, unless disposable, are reused from one test to the next. As a result, at least the tips of the probes must be cleaned between each test to avoid cross contamination. Conventionally, the probes undergo a wet “tip wash” process. That is, they are cleaned in between uses with a liquid solvent, such as Dimethyl Sulfoxide (DMSO), or at times simply water.

These methods and apparatus for cleaning and conditioning fluid handling devices have certain disadvantages. For example, the wet “tip wash” process takes a relatively long amount of time. This process can also be ineffective in sufficiently cleaning the probe tips between tests. Furthermore, disposing the used solvents from the wet process presents many issues and challenges, not the least of which is environmental.

Thus, there is a need for improved methods and apparatus for cleaning and surface conditioning fluid handling devices.

### SUMMARY OF THE INVENTION

The present invention generally relates to an apparatus and method for cleaning at least a portion of a fluid handling device, which device includes a plurality of conductive probes, using plasma. This plasma is generated from a voltage source including a center tapped transformer.

In accordance with an embodiment, there is provided an apparatus for cleaning objects using plasma, comprising a plurality of elongated dielectric barrier members arranged adjacent each other; a first set of electrodes arranged to be coupled to a voltage source at a first voltage, each electrode of the first set contained within, and extending substantially along the length of, a first set of the elongated dielectric barrier members; and a second set of electrodes arranged to be coupled to a voltage source at a second voltage, each electrode of the second set contained within, and extending substantially along the length of, a second set of the elongated dielectric barrier members; whereby, when the first and second voltages are applied, dielectric barrier discharges are created that form plasma between adjacent elongated dielectric barrier members for cleaning at least a portion of the objects.

In accordance with another embodiment, there is provided an apparatus for cleaning objects using plasma, comprising a plurality of elongated dielectric barrier members arranged adjacent each other in a microtiter plate matrix format; a first set of electrodes arranged to be coupled to a voltage source at a first voltage, each electrode of the first set contained within, and extending substantially along the length of, a first set of the elongated dielectric barrier members; and a second set of electrodes arranged to be coupled to a voltage source at a second voltage, each electrode of the second set contained within, and extending substantially along the length of, a second set of the elongated dielectric barrier members; whereby, when the first and second voltages are applied, dielectric barrier discharges are created that form plasma between adjacent elongated dielectric barrier members for cleaning at least a portion of the objects.

In accordance with yet another embodiment, there is provided a method for cleaning at least a portion of a plurality of objects, comprising providing a plurality of elongated dielectric barrier members having a first and second set of electrodes arranged therein; introducing the objects proximate the elongated dielectric barrier members; and generating a dielectric barrier discharge to form plasma between the elongated dielectric barrier members for cleaning at least a portion of each of the objects.

In accordance with an embodiment of the present invention, there is provided an apparatus for cleaning objects using plasma, comprising a plurality of elongated dielectric barrier plates arranged adjacent each other; a first set of electrodes arranged to be coupled to a voltage source at a first voltage, each electrode of the first set contained within, and extending substantially along the length of, a first set of the elongated dielectric barrier plates; and a second set of electrodes arranged to be coupled to a voltage source at a second voltage, each electrode of the second set contained within, and extending substantially along the length of, a second set of the elongated dielectric barrier plates; whereby, when the first and second voltages are applied, dielectric barrier discharges are created to form plasma between adjacent elongated dielectric barrier plates to clean at least a portion of the objects.

### BRIEF DESCRIPTION OF THE DRAWINGS

So the manner in which the above recited features of the present invention can be understood in detail, a more particular description of embodiments of the present invention, briefly summarized above, may be had by reference to embodiments, some of which are illustrated in the appended drawings. It is to be noted; however, the appended drawings illustrate only typical embodiments of embodiments of the present invention and are therefore not to be considered limiting of its scope, for the present invention may admit to other equally effective embodiments.

FIG. 1A is a top, partial perspective view of a plurality of conductive probes being introduced to a plurality of elongated dielectric barrier members with coupled inner electrodes in accordance with an embodiment of the present invention;

FIG. 1B is a top, partial perspective view of one conductive probe being introduced to one dielectric barrier member with a coupled inner electrode in accordance with an embodiment of the present invention;

FIG. 2 is a front, expanded view of the device and the conductive probes of FIG. 1A showing the components electrically coupled;

FIG. 3A is a cross sectional schematic view of the device and a conductive probe of FIG. 1A showing the dimensions and spacing among the components;

FIG. 3B is a cross sectional schematic view of the device of FIG. 1A showing a conductive probe proximate the top of a dielectric barrier member;

FIG. 4 is a schematic view of an alternative power supply in accordance with another embodiment of the present invention;

FIG. 5 is a front, expanded view of the device and the conductive probes of FIG. 1A, the device being electrically coupled to the power supply of FIG. 4;

FIG. 6 is a front, expanded view of a device of FIG. 5, with non-conductive, or electrically isolated probes, the device being electrically coupled to the power supply of FIG. 4;

FIG. 7 is a partial, top plan view showing the staggered connection of electrical contacts to bus bars (contact planes) for use with the power supply shown in FIG. 4;

FIG. 8 is a is a top plan view of a matrix or array of elongated dielectric barrier members shown in the previous figures arranged in a microtiter plate format; and

FIG. 9 represents a graph of the relative concentrations of different chemical and particle species of plasma in time after the initiation of a single microdischarge that forms atmospheric pressure plasma in air.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments of the present invention as defined by the appended claims.

The headings used herein are for organizational purposes only and are not meant to be used to limit the scope of the description or the claims. As used throughout this application, the word “can” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

The term “plasma” is used to describe a quasi-neutral gas of charged and neutral species characterized by a collective behavior governed by coulomb interactions. Plasma is typically obtained when sufficient energy, higher than the ionization energy of the neutral species, is added to the gas causing ionization and the production of ions and electrons. The energy can be in the form of an externally applied electromagnetic field, electrostatic field, or heat. The plasma becomes an electrically conducting medium in which there are roughly equal numbers of positively and negatively charged particles, produced when the atoms/molecules in a gas become ionized.

A plasma discharge is produced when an electric field of sufficient intensity is applied to a volume of gas. Free electrons are then subsequently accelerated to sufficient energies to produce electron-ion pairs through inelastic collisions. As the density of electrons increase, further inelastic electron atom/molecule collisions will result in the production of further charged carriers and a variety of other species. The species may include excited and metastable states of atoms and molecules, photons, free radicals, molecular fragments, and monomers.

The term “metastable” describes a type of atom/molecule excited to an upper electronic quantum level. Here, quantum mechanical selection rules forbid a spontaneous transition to a lower level. As a result, such species have long, excited lifetimes. For example, whereas excited states with quantum mechanically allowed transitions typically have lifetimes on the order of about 10⁻⁹ to 10⁻⁸ seconds before relaxing and emitting a photon, metastable states can exist for about 10⁻⁶ to 10¹ seconds. The long metastable lifetimes allow for a higher probability of the excited species to transfer their energies directly through a collision with another compound and result in ionization and/or dissociative processes.

The plasma species are chemically active and/or can physically modify the surface of materials and may therefore serve to form new chemical compounds and/or modify existing compounds. For example, the plasma species can modify existing compounds through ionization, dissociation, oxidation, reduction, attachment, and recombination.

A non-thermal, or non-equilibrium, plasma is one in which the temperature of the plasma electrons is higher than the temperature of the ionic and neutral species. Within atmospheric pressure, non-thermal plasma, there is typically an abundance of the aforementioned energetic and reactive particles (i.e., species), such as ultraviolet photons, excited and/or metastable atoms and molecules, atomic and molecular ions, and free radicals. For example, within air plasma, there are excited, metastable, and ionic species of N₂, N, O₂, O, free radicals such as OH, HO₂, NO, O, and O₃, and ultraviolet photons ranging in wavelengths from 200 to 400 nanometers resulting from N₂, NO, and OH emissions. In addition to the energetic (fast) plasma electrons, embodiments of the present invention harness and use these “other” particles to clean and surface condition portions of liquid handling devices, such as probes, and the like.

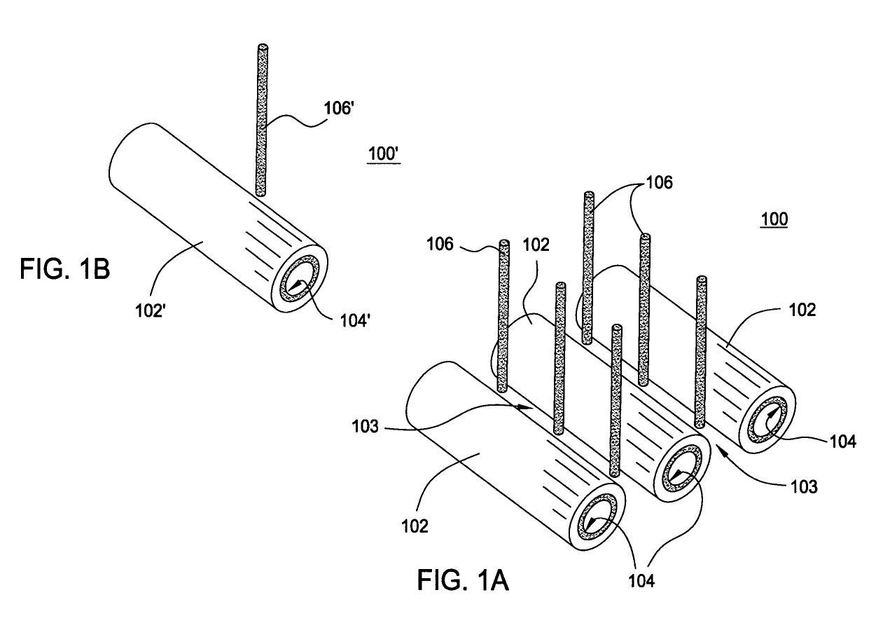

Referring to FIG. 1A, a partial view of a non-thermal atmospheric pressure plasma cleaning device 100 in accordance with an embodiment of the present invention is disclosed. The device 100 includes a plurality of elongated dielectric barrier members 102 arranged in a matrix or array and lying in a single plane. The members 102 are substantially regularly spaced apart from each other and form a gap 103 between adjacent members 102.

Each dielectric barrier member 102 includes an inner electrode 104 extending within, and substantially along the length of, respective elongated dielectric barrier members 102. A plurality of conductive probes 106 are shown extending into the open spaces or gaps 103 between the plurality of dielectric barrier members 102. In one embodiment, the probes 102 may be part of a fluid handling device. As such, the probes 102 are attached to and extend from a fluid handling device (not shown), which may be part of a microtiter plate test bed set up. In other embodiments, the probes 102 may be any form of conductive element that would benefit from plasma cleaning and surface conditioning.

The elongated dielectric barrier members 102 are made of any type of material capable of providing a surface for a dielectric barrier discharge of atmospheric pressure plasma (described below). Dielectric barrier material useful in this embodiment of the present invention includes, but is not limited to, ceramic, glass, plastic, polymer epoxy, or a composite of one or more such materials, such as fiberglass or a ceramic filled resin (available from Cotronics Corp., Wetherill Park, Australia).

In one embodiment, a ceramic dielectric barrier is alumina or aluminum nitride. In another embodiment, a ceramic dielectric barrier is a machinable glass ceramic (available from Corning Incorporated, Corning, N.Y.). In yet another embodiment of the present invention, a glass dielectric barrier is a borosilicate glass (also available from Corning Incorporated, Coming, N.Y.). In still another embodiment, a glass dielectric barrier is quartz (available from GE Quartz, Inc., Willoughby, Ohio). In an embodiment of the present invention, a plastic dielectric barrier is polymethyl methacrylate (PLEXIGLASS and LUCITE, available from Dupont, Inc., Wilmington, Del.). In yet another embodiment of the present invention, a plastic dielectric barrier is polycarbonate (also available from Dupont, Inc., Wilmington, Del.). In yet another embodiment, a plastic dielectric barrier is a fluoropolymer (available from Dupont, Inc., Wilmington, Del.). In another embodiment, a plastic dielectric barrier is a polyimide film (KAPTON, available from Dupont, Inc., Wilmington, Del.). Dielectric barrier materials useful in the present invention typically have dielectric constants ranging between 2 and 30. For example, in one embodiment that uses a polyimide film plastic such as KAPTON, at 50% relative humidity, with a dielectric strength of 7700 Volts/mil, the film would have a dielectric constant of about 3.5.

The inner electrode 104 may comprise any conductive material, including metals, alloys and conductive compounds. In one embodiment, a metal may be used. Metals useful in this embodiment of the present invention include, but are not limited to, copper, silver, aluminum, and combinations thereof. In another embodiment of the present invention, an alloy of metals may be used as the inner electrode 104. Alloys useful in this embodiment of the present invention include, but are not limited to, stainless steel, brass, and bronze. In another embodiment of the present invention, a conductive compound may be used. Conductive compounds useful in the present invention include, but are not limited to, indium-tin-oxide.

The inner electrodes 104 of embodiments of the present invention may be formed using any method known in the art. In one embodiment of the present invention, the inner electrodes 104 may be formed using a foil. In another embodiment of the present invention, the inner electrodes 104 may be formed using a wire. In yet another embodiment of the present invention, the inner electrodes 104 may be formed using a solid block of conductive material. In another embodiment of the present invention, the inner electrodes 104 may be deposited as an integral layer directly onto the inner core of the dielectric barrier members 102. In one such embodiment, an inner electrode 104 may be formed using a conductive paint, which is applied to the inner core of the elongated dielectric barrier members 102.

In one use of the present invention, the conductive probes 106 are part of the fluid handling device and are introduced in the gap 103, i.e., proximate the elongated dielectric barrier members 102 of the plasma cleaning device 100. Use of the term “probe” is meant to include, but not be limited to, probes, cannulas, pin tools, pipettes and spray heads or any portion of a fluid handling device that is capable of carrying fluid. These portions are generally hollow to carry the fluid but may be solid and include a surface area capable of retaining fluid. All of these different types of fluid handling portions of a fluid handling device are collectively referred to in this application as “probes.” In an embodiment, the probe is conductive and is made of conductive material similar to that material described above in connection with the inner electrode 104.

FIG. 1B depicts a non-thermal atmospheric pressure plasma cleaning device 100′ in accordance with another embodiment of the present invention. In this embodiment, a dielectric barrier member 102′ and one inner electrode 104′ are shown. In addition, one conductive probe 106′ is shown being introduced proximate the dielectric 102′. Each conductive probe 106 may be introduced proximate one (FIG. 1B) or many (FIG. 1A) elongated dielectric barrier members 102. When each conductive probe 106 is proximate one elongated dielectric barrier member 102, the conductive probe 106 may be introduced proximate the top of the elongated dielectric barrier member 102. When each conductive probe 106 is introduced proximate two elongated dielectric barrier members 102, the conductive probe 106 may be introduced either proximate or between the two elongated dielectric barrier members 102 (as shown in FIG. 1A).

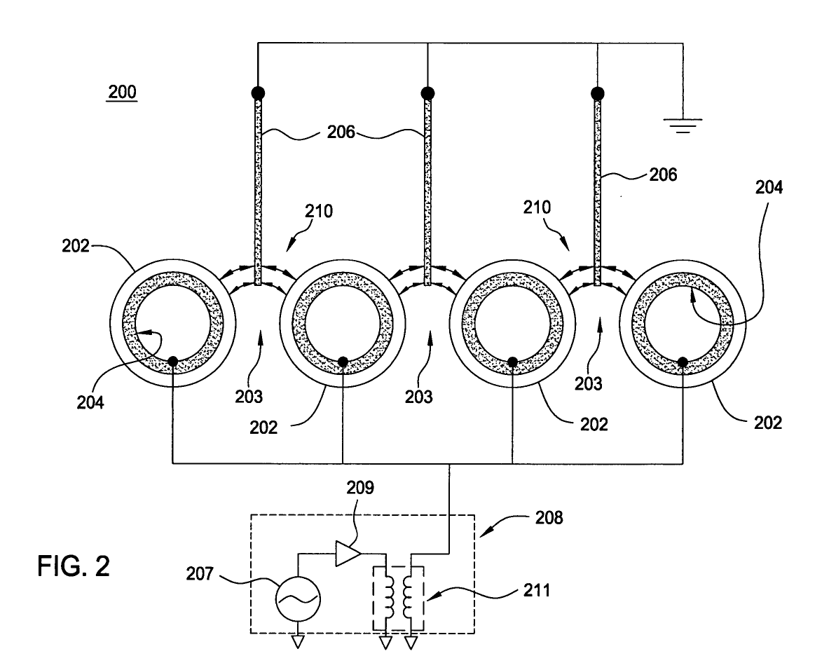

Referring to FIG. 2, a cross sectional portion of an atmospheric pressure plasma device is designated as 200. The portion 200 shown includes a plurality of inner electrodes 204 of each elongated dielectric barrier member 202 electrically connected to an AC voltage source 208. The conductive probes 206 are electrically grounded with respect to the AC voltage source 208. The AC voltage source 208 in this embodiment includes an AC source 207, a power amplifier 209 and a transformer 211 to supply voltage to the inner electrodes 204.

In certain embodiments of the atmospheric pressure plasma device 200, a dielectric barrier discharge (DBD) (also known as a “silent discharge”) technique is used to create microdischarges of atmospheric pressure plasma. In a DBD technique, a sinusoidal voltage from an AC source 207 is applied to at least one inner electrode 204, within an insulating dielectric barrier member 202. Dielectric barrier discharge techniques have been described in “Dielectric-barrier Discharges: Their History, Discharge Physics, and Industrial Applications”, Plasma Chemistry and Plasma Processing, Vol. 23, No. 1, March 2003, and “Filamentary, Patterned, and Diffuse Barrier Discharges”, IEEE Transactions on Plasma Science, Vol. 30, No. 4, August 2002, both authored by U. Kogelschatz, the entire disclosures of which are incorporated by reference herein.

A substantially uniform atmospheric pressure plasma in air is obtained by placing a dielectric barrier in between the electrode 204 and the conductive probe 206 to control the discharge, i.e., choke the production of atmospheric pressure plasma. That is, before the discharge can become an arc, the dielectric barrier 202 chokes the production of the discharge. Because this embodiment is operated using an AC voltage source, the discharge oscillates in a sinusoidal cycle. The microdischarges generally occur near the peak of each sinusoid. One advantage to this embodiment is that controlled, non-equilibrium plasmas can be generated at atmospheric pressure using a relatively simple and efficient technique.

In operation, the AC voltage source 208 applies a sinusoidal voltage to the inner electrodes 204. Then, the plurality of conductive probes 206 are introduced into the gap 203 between adjacent elongated dielectric barriers 202. A dielectric barrier discharge (DBD) is produced. This DBD forms atmospheric pressure plasma, represented by arrows 210. In an embodiment of the present invention, atmospheric pressure plasma is obtained when, during one phase of the applied AC voltage, charges accumulate between the dielectric surface and the opposing electrode until the electric field is sufficiently high enough to initiate an electrical discharge through the gas gap (also known as “gas breakdown”).

During an electrical discharge, an electric field from the redistributed charge densities may oppose the applied electric field and the discharge is terminated. In one embodiment, the applied voltage-discharge termination process may be repeated at a higher voltage portion of the same phase of the applied AC voltage or during the next phase of the applied AC voltage. A point discharge generally develops within a high electric field region near the tip of the conductive probe 206.

To create the necessary DBD for an embodiment of the present invention, the AC voltage source 208 includes an AC power amplifier 209 and a high voltage transformer 211. The frequency ranges from about 10,000 Hertz to 20,000 Hertz, sinusoidal. The power amplifier has an output voltage of from about 0 Volts (rms) to about 22.5 Volts (rms) with an output power of 500 watts. The high voltage transformer ranges from about 0 V (rms) to about 7,000 Volts (rms) (which is about 10,000 volts (peak)). Depending on the geometry and gas used for the plasma device, the applied voltages can range from about 500 to about 10,000 Volts (peak), with frequencies ranging from line frequencies of about 50 Hertz up to about 20 Megahertz.

In an embodiment of the present invention, the frequency of a power source may range from about 50 Hertz up to about 20 Megahertz. In another embodiment of the present invention, the voltage and frequency may range from about 5,000 to about 15,000 Volts (peak) and about 50 Hertz to about 50,000 Hertz, respectively.

The gas used in the plasma device 200 of the present invention can be ambient air, pure oxygen, any one of the rare gases, or a combination of each such as a mixture of air or oxygen with argon and/or helium. Also, the gas may include an additive, such as hydrogen peroxide, or organic compounds such as methanol, ethanol, ethylene or isopropynol to enhance specific atmospheric pressure plasma cleaning properties.

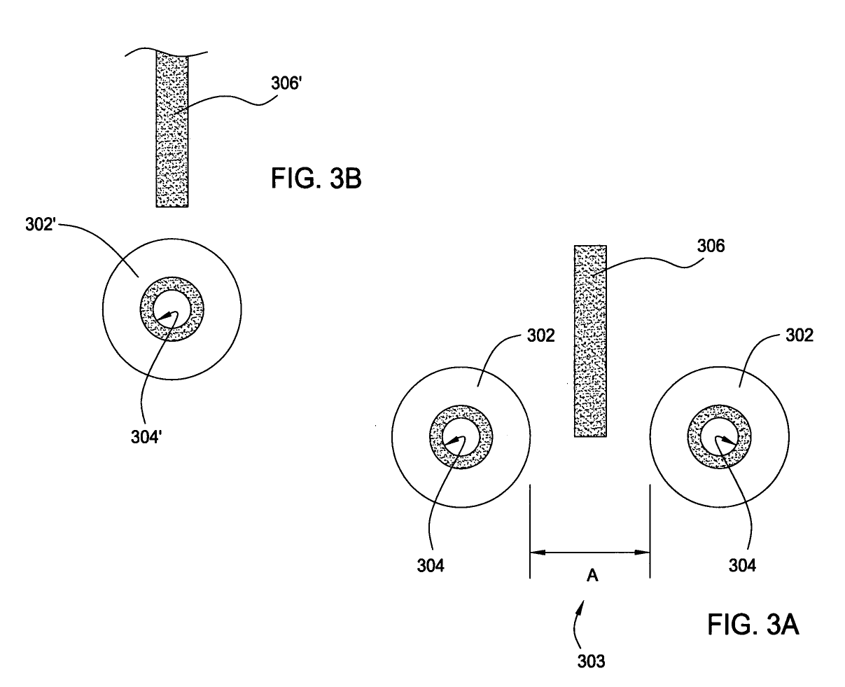

FIG. 3A depicts an example of the geometry and relationship among components in accordance with an embodiment of the present invention. The elongated dielectric barrier member 302 (shown in cross section) may comprise, for example, an elongated hollow tube with a hollow inner electrode 304 extended substantially the length of the elongated dielectric barrier member 302. Alternatively, the elongated dielectric barrier member 302 may be solid with a solid inner electrode 304. The elongated dielectric barrier 302 may comprise different shapes as well. For example, and not in any way limiting the scope of the present invention, the shape of the elongated dielectric barrier may be, by way of example only, tubular, circular, square, rectangular, oval, polygonal, triangular, trapezoidal, rhombus and irregular. If tubular, each dielectric barrier tube is about 2 mm in diameter and 75 to 120 mm long.

In this embodiment, the elongated dielectric barrier members 302 are placed adjacent one another, defining a plane. They are spaced at regular intervals and form a gap 303, designated as spacing A. Alternatively, the members 302 can be staggered in a non-planar arrangement with respect to one another. The spacing A is sized to allow at least a portion of each of the plurality of probes to be introduced proximate or between the elongated dielectric barrier members.

The gap 303 or spacing A can approach zero, provided there is a sufficient gap to allow air or other gas mixture to flow through the elongated dielectric barrier members 302. Spacing A or gap 303 can range from about 0 mm to about 10 mm. The spacing A or gap 303 may also range from about 2 mm to about 9.5 mm. In one embodiment, the spacing A is equal to about 9 mm. In another embodiment, the spacing A is equal to about 4.5 mm. In yet another embodiment, the spacing A is equal to about 2.25 mm.

In an embodiment, where both the probes 306 and the plurality of elongated dielectric barrier members 302 are substantially tubular (each having substantially the same respective diameter) and the plurality of probes 306 are substantially tubular (each having substantially the same respective diameter), the probe 306 diameter is relatively smaller than the diameter of the plurality of elongated dielectric barrier members. Thus, even if the spacing A (or gap 303) between the elongated dielectric barrier members 302 approaches 0 mm, the probes 306 are still capable of being introduced proximate, if not between, a pair of elongated dielectric members 302, sufficient to be exposed to a DBD.

Alternatively, as shown in FIG. 3B, the probes 306′ can be introduced generally proximate the top of each elongated dielectric barrier member 302′. FIG. 3B depicts only one probe 306′ and one dielectric 302′ but it is to be understood the present invention contemplates a plurality of probes 306′ being introduced proximate the top of a plurality of respective dielectric barrier members 302′.

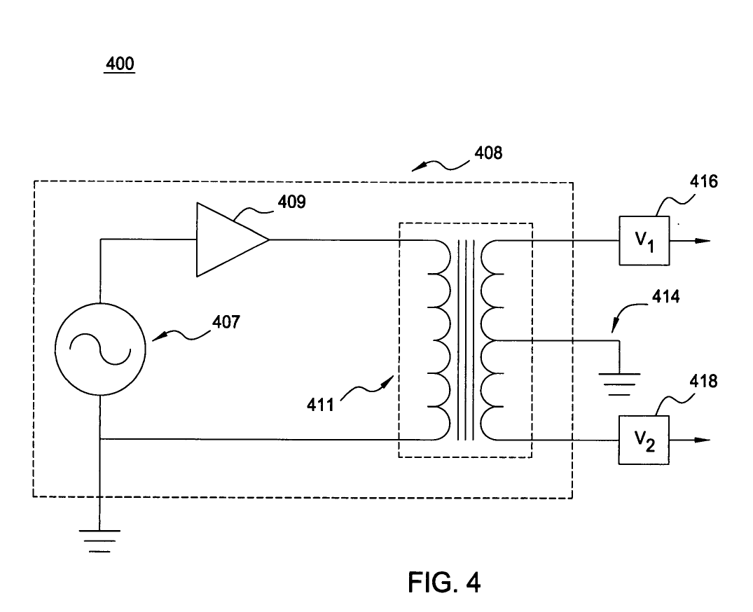

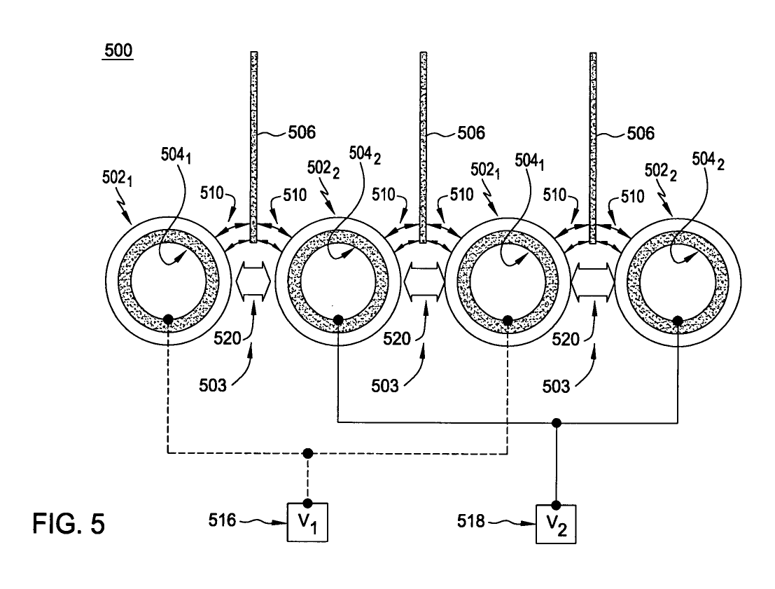

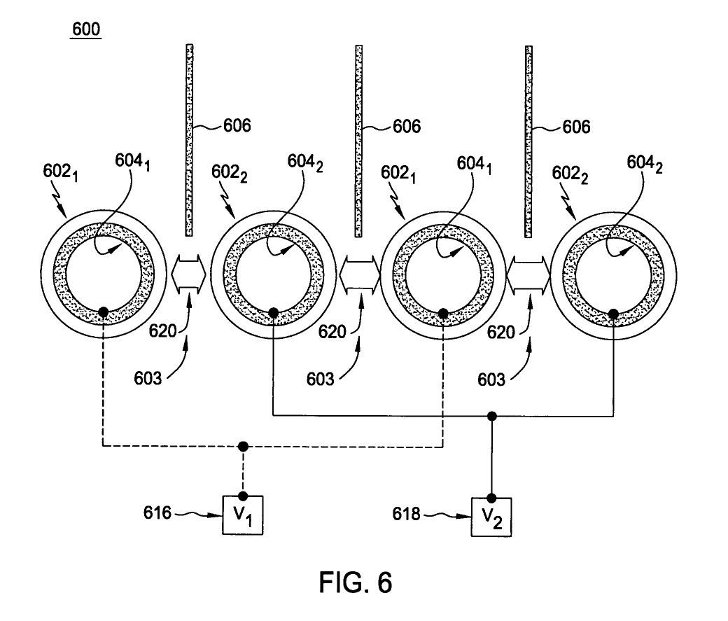

FIG. 4 is a schematic view of an alternative power supply in accordance with another embodiment of the present invention. Here, the power supply comprises a voltage source 408. The voltage source 408 comprises an AC source 407, a power amplifier 409 and a center tapped transformer 411 to provide two voltage potentials from a center tapped ground 414. The first voltage (V₁) 416 is coupled to a first set of elongated dielectric barrier members and the second voltage (V₂) 418 is coupled to a second set of elongated dielectric barrier members, as shown in FIGS. 5 and 6 and described herein.

FIG. 5 is a cross sectional portion of an atmospheric pressure plasma device 500 coupled to the voltage source 408 including the center tapped transformer 411, as described in FIG. 4, in accordance with another embodiment of the present invention. The portion 500 comprises a first plurality of inner electrodes 504, of each elongated dielectric barrier member 502, electrically connected to the voltage source 408 via a first voltage (V₁) 516. The portion 500 further comprises a second plurality of inner electrodes 5042 of each elongated dielectric barrier member 5022 electrically connected to the voltage source 408 via the second voltage (V₂) 518. The conductive probes 506 are electrically grounded with respect to the voltage source 408. The voltage source 408 supplies the two voltages to the inner electrodes 504. In this alternative embodiment, for example, V₁=−V₂.

As shown in FIG. 5, a dielectric barrier discharge (DBD) technique is again used to create microdischarges of atmospheric pressure plasma. In the DBD technique, two equal and opposite sinusoidal voltages from the AC source 407 are applied to the first and second sets, respectively, of at least one pair of inner electrodes 504, within corresponding insulating dielectric barrier members 502.

Substantially uniform atmospheric pressure plasma in air is obtained by placing dielectric barriers 502₁ and 502₂ in between the electrodes 504₁ and 504₂, respectively, and the conductive probes 506 to control the discharge, i.e., choke the production of atmospheric pressure plasma. That is, before the discharge can become an arc, the dielectric barriers 502 choke the production of the discharge. Because this embodiment is operated using an AC voltage source having two voltage potentials, the discharge oscillates in two substantially corresponding sinusoidal cycles. The microdischarges generally occur near the peak of each sinusoid.

In operation, the voltage source 408 applies two sinusoidal voltages V₁ and V₂ to the inner electrodes 504₁ and 504₂, respectively. Then, the plurality of conductive probes 506 are introduced into the gap 503 between adjacent elongated dielectric barriers 502₁ and 502₂. A DBD is produced. This DBD forms atmospheric pressure plasma, represented by arrows 510. In addition to this DBD, an additional discharge 520 is produced. This is due to the voltage difference between adjacent inner electrodes 504₁ and 504₂. This additional discharge is represented by the larger arrows.

To create the necessary DBDs 510 and 520 for an embodiment of the present invention, the voltage source 408 includes the AC power amplifier 409 and the high voltage center tapped transformer 411. Similar to the source 208 of FIG. 2, the frequency ranges from about 10,000 Hertz to 20,000 Hertz, sinusoidal. The power amplifier 409 has an output voltage of from about 0 Volts (rms) to about 22.5 Volts (rms) with an output power of about 500 watts. The high voltage center tapped transformer 411 ranges from about −4000 Volts (rms) to about 4,000 Volts (rms). Depending on the geometry and gas used for the plasma device, the applied voltages can range from about 500 to about 10,000 Volts (peak), with frequencies ranging from line frequencies of about 50 Hertz up to about 20 Megahertz. Here, the total voltage between the dielectric barriers is about 10,000 Volts, while the probe will only see about 5,000 Volts.

In an embodiment of the present invention, the frequency of a power source may range from about 50 Hertz up to about 20 Megahertz. In another embodiment of the present invention, the voltage and frequency may range from about 5,000 to about 15,000 Volts (peak) and about 50 Hertz to about 50,000 Hertz, respectively.

The gas used in the plasma device 500 of the present invention can be ambient air, pure oxygen, any one of the rare gases, or a combination of each such as a mixture of air or oxygen with argon and/or helium. Also, the gas may include an additive, such as hydrogen peroxide, or organic compounds such as methanol, ethanol, ethylene or isopropynol to enhance specific atmospheric pressure plasma cleaning properties.

FIG. 6 is a cross sectional portion of an atmospheric pressure plasma device 600 coupled to the voltage supply 408 including the center tapped transformer 411, as described in FIG. 4, in accordance with yet another embodiment of the present invention. The portion 600 comprises a first plurality of inner electrodes 604₁ of each elongated dielectric barrier member 602₁ electrically connected to the voltage source 408 via a first voltage (V₁) 616. The portion 600 further comprises a second plurality of inner electrodes 604₂ of each elongated dielectric barrier member 602₂ electrically connected to the voltage source 408 via the second voltage (V₂) 618. Here, the probes 606 are non-conductive, or conductive but electrically isolated, and are therefore not electrically grounded with respect to the voltage source 408. The voltage source 408 supplies the two voltages to the inner electrodes 604. In this embodiment, for example, V₁=−V₂.

As shown in FIG. 6, a dielectric DBD technique is again used to create microdischarges of atmospheric pressure plasma. In the DBD technique, two equal and opposite sinusoidal voltages from the AC source 407 are applied to the first and second sets, respectively, of at least one pair of inner electrodes 604, within corresponding insulating dielectric barrier members 602. Here, no DBD is formed between the dielectrics 602 and the probes 606 because the probes are non-conductive or electrically isolated. Instead, the DBD is only formed between paired dielectrics 602₁ and 602₂ because of the voltage difference between respective pairs of inner electrodes 604₁ and 604₂.

In operation, the voltage source 408 applies two sinusoidal voltages V₁ and V₂ to the inner electrodes 604₁ and 604₂, respectively. A DBD 620 is produced. This is due to the voltage difference between adjacent inner electrodes 604₁ and 604₂. This additional discharge is represented by the larger arrows. To create the necessary DBDs 620 for this embodiment of the present invention, the same requirements of the voltage source 408 as discussed above with respect to FIGS. 4 and 5 apply here. The gas used in the plasma device 600 of this embodiment of the present invention is similar to that discussed above with respect to FIG. 5.

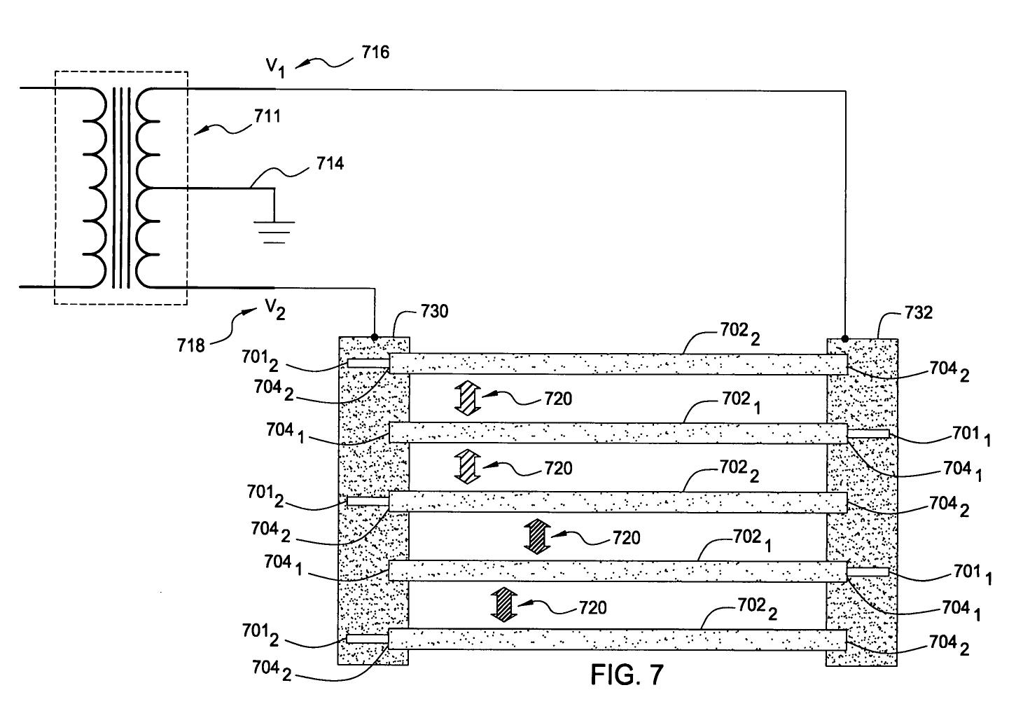

FIG. 7 is a partial, top plan view showing the staggered connection of electrical contacts to bus bars (contact planes) for use with an voltage source 408 similar to that shown in FIG. 4. The elongated dielectric barrier members 702₁, 702₂ may comprise either tubes or plates (or any other variation of shapes) as described hereinabove and in the commonly assigned patent applications discussed previously and incorporated herein by reference in their entirety.

As shown, the inner electrodes 704, of the elongated dielectric members 702₁ are electrically coupled to bus bar 732 via contacts 701₁. The inner electrodes 704₂ of the elongated dielectric members 702₂ are electrically coupled to bus bar 730 via contacts 701₂. As described before, in this configuration, plasma is formed between adjacent members 702₁ and 702₂ as designated by the large arrows 720.

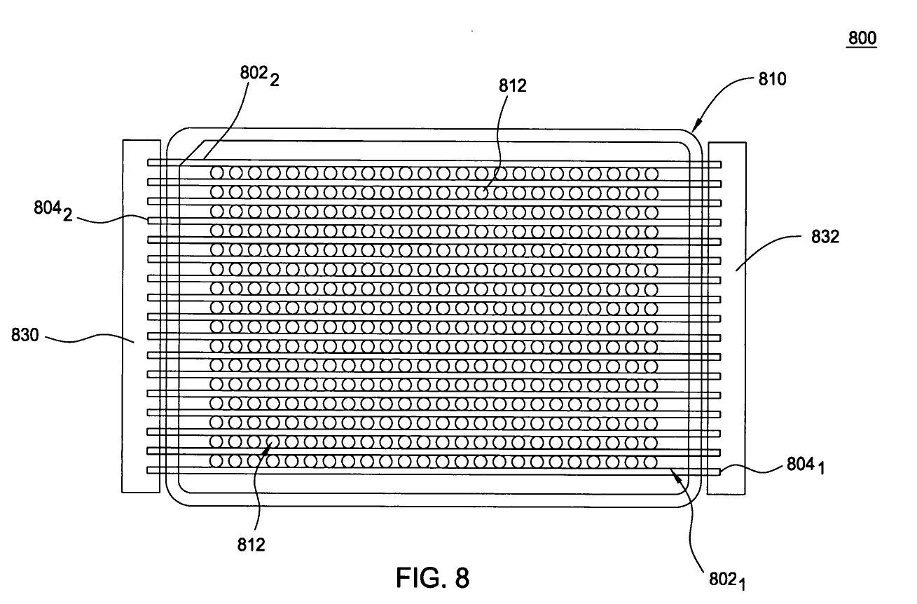

FIG. 8 is a top plan view of the above described plasma device of FIGS. 5 and 6 configured and arranged in a standard microtiter plate format 800. For example, the microtiter plate format may be sized to accommodate 96 openings for receiving a plurality of fluid handling probes. Alternatively, the microtiter plate is sized to accommodate 384 openings for receiving a plurality of probes. As an alternative, the wells and the pitch between rows of wells of the microtiter plate are sized to accommodate 1536 openings for receiving a plurality of probes.

Microtiter plates or microplates, similar to the one depicted in FIG. 8, are small, usually plastic, reaction vessels. The microplate 800 has a tray or cassette 810 covered with wells or dimples 812 arranged in orderly rows. These wells 812 are used to conduct separate chemical reactions during a fluid testing step. The large number of wells, which typically number 96, 384 (as shown in FIG. 8) or 1536, depending upon the well size and pitch between rows of wells of the microplate allow for many different reactions to take place at the same time. Microplates are ideal for high-throughput screening and research. They allow miniaturization of assays and are suitable for many applications, including drug testing, genetic study, and combinatorial chemistry.

The microplate 800 has been equipped with an embodiment of the present invention similar to the configuration discussed with reference to FIGS. 5 and 6. Situated in rows on the top surface of the microplate 800 and between the wells 812 are a plurality of elongated dielectric barrier members 802 similar to those described hereinabove.

The inner electrodes 804₁ of the elongated dielectric barrier members 802₁ are electrically coupled to V₁ of the voltage source through contact plane 832 of the cassette 810. The inner electrodes 804₂ of the elongated dielectric barrier members 802₂ are electrically coupled to V₂ of the AC voltage source through contact planes 830 of the cassette 810.

The elongated dielectric barrier members 802 are respectively spaced apart in this embodiment a pitch of about 4.5 mm. In alternative embodiments, where the well count is 96, the members 802 are spaced apart a pitch of about 9 mm. In yet another embodiment, where the wells 812 numbered 1536, the pitch is 2.25 mm. During a cleaning step, the wells 812 of the microplate 800 do not necessarily function as liquid holding devices. Rather, the wells 812 are used to allow receiving space for the probes when the probes are fully introduced between the elongated dielectric barrier members 802.

In operation, the microplate 800 is placed in, for example, a deck mounted wash station. In, for example, an automated microplate liquid handling instrumentation, the system performs an assay test. Then, at least the probe tips of the fluid handling device require cleaning. As such, the fluid handling device enters the wash station. A set of automated commands initiate and control the probes to be introduced to the microplate 800 proximate the stacked elongated dielectric barrier members 802. At or about the same time, the AC voltage power source is initiated. Alternatively, the power source remains on during an extended period.

During the power-on phase, as the probes are introduced to the elongated dielectric members 802 of the microplate 800, DBDs of plasma are formed between the members 802 and the probes (see, e.g., FIG. 5) or just between the members (see, e.g., FIG. 6).

In an embodiment of the present invention where the probes are hollow, the reactive and energetic components or species of the plasma are repeatedly aspirated into the probes, using the fluid handling devices′ aspirating and dispensing capabilities. The aspiration volume, rate and frequency are determined by the desired amount of cleaning/sterilization required.

Any volatized contaminants and other products from the plasma may be vented through the bottom of the microplate 800 by coupling the bottom of the tray 810 to a region of negative pressure such as a modest vacuum. This vacuum may be in communication with the wells 812 and is capable of drawing down plasma and reactive byproducts through to the bottom of the device and into an exhaust manifold (not shown) of the cleaning station test set up.

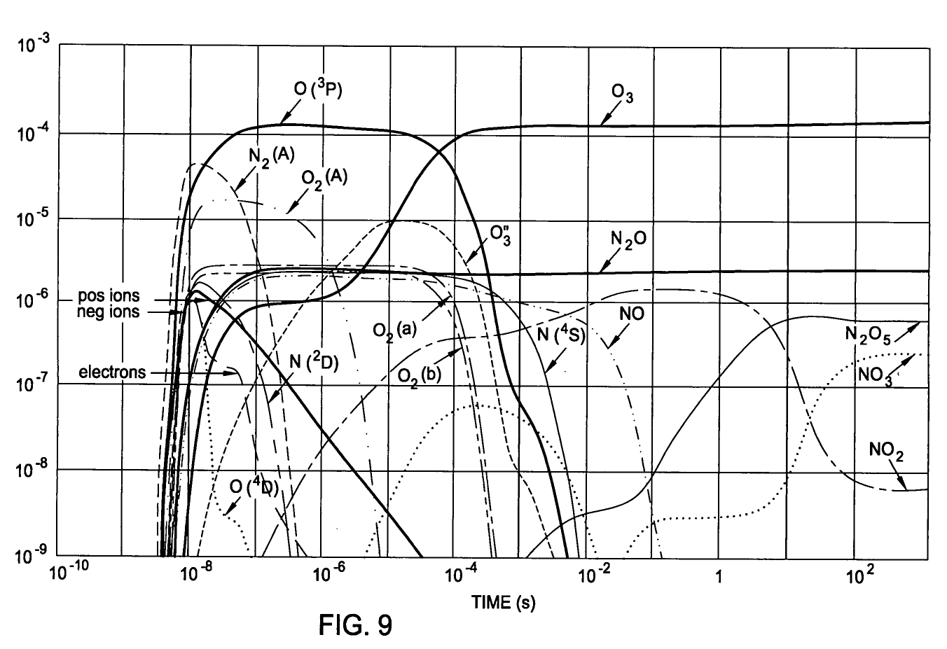

In an embodiment, ions, excited and metastables species (corresponding emitted photons), and free radicals are found in the atmospheric pressure plasma and remain long enough to remove substantially all of the impurities and contaminates left from the previous test performed by the fluid handling device's probes. These particle species remain longer (see FIG. 9) than the initial plasma formed from a DBD or microdischarge and are therefore effective in cleaning the probes in preparation for the next test as the initially formed plasma itself.

In particular, FIG. 9 represents a graph of the relative concentrations of different particle species in time after the initiation of a single microdischarge forming atmospheric pressure plasma in air. Metastables are represented by N₂(A) and N₂(B). Free radicals are represented by O₃, O(³P), N(⁴S) and NO. Free radicals and metastables are represented by O(¹D) and N(²D). In non-equilibrium microdischarges, the fast electrons created by the discharge mechanism mainly initiate the chemical reactions in the atmospheric pressure plasma. The fast electrons can inelastically collide with gas molecules and ionize, dissociate, and/or excite them to higher energy levels, thereby losing part of their energy, which is replenished by the electric field. The resulting ionic, free radical, and excited species can then, due to their high internal energies or reactivities, either dissociate or initiate other reactions.

In plasma chemistry, the transfer of energy, via electrons, to the species that take part in the reactions must be efficient. This can be accomplished by a very short discharge pulse. This is what occurs in a microdischarge. FIG. 9 shows the evolution of the different particle species initiated by a single microdischarge in “air” (80% N₂, plus 20% O₂). The short current pulse of roughly 10 ns duration deposits energy in various excited levels of N₂ and O₂, some of which lead to dissociation and finally to the formation of ozone and different nitrogen oxides. After about 50 ns, most charge carriers have disappeared and the chemical reactions proceed without major interference from charge carriers and additional gas heating.

While the foregoing is directed to embodiments of the present invention, other and further embodiments of the invention may be devised without departing from the basic scope thereof, and the scope thereof is determined by the claims that follow.

What is claimed is:

1. An apparatus for cleaning objects using plasma, comprising:
a plurality of elongated dielectric barrier members arranged adjacent each other;
a first set of electrodes arranged to be coupled to a voltage source at a first voltage, each electrode of the first set contained within, and extending substantially along the length of, a first set of the elongated dielectric barrier members; and
a second set of electrodes arranged to be coupled to a voltage source at a second voltage, each electrode of the second set contained within, and extending substantially along the length of, a second set of the elongated dielectric barrier members;
whereby, when the first and second voltages are applied, dielectric barrier discharges are created that form plasma between adjacent elongated dielectric barrier members for cleaning at least a portion of the objects.

2. The apparatus of claim 1, wherein the objects comprise a plurality of conductive probes arranged and configured to be introduced proximate the plurality of elongated dielectric barrier members.

3. The apparatus of claim 1, wherein the objects comprise a plurality of non-conductive or electrically isolated probes arranged and configured to be introduced proximate the plurality of elongated dielectric barrier members.

4. The apparatus of claim 2, further comprising a voltage source electrically coupled to the first and second set of electrodes for producing a dielectric barrier discharge between the conductive probes and the plurality of elongated dielectric barrier members.

5. The apparatus of claim 3, further comprising a voltage source electrically coupled to the first and second set of electrodes for producing a dielectric barrier discharge between the plurality of elongated dielectric barrier members.

6. The apparatus of claim 1, wherein the elongated dielectric barrier members are spaced apart from each other at substantially regular intervals to define predetermined gaps therebetween.

7. The apparatus of claim 6, wherein the predetermined gaps range from about 0 mm to about 10 mm.

8. The apparatus of claim 1, wherein each of the electrodes are arranged to form an aperture within and extending substantially the length of each respective elongated dielectric barrier member.

9. The apparatus of claim 1, wherein each of the electrodes are arranged to form a solid core within and extending substantially the length of each respective elongated dielectric barrier member.

10. The apparatus of claim 1, wherein each of the electrodes are deposited within each respective one of the elongated dielectric barrier members.

11. The apparatus of claim 1, wherein each of the electrodes are discrete components secured within each of the elongated dielectric barrier members.

12. The apparatus of claim 1, wherein the elongated dielectric barrier members are arranged in a microtiter plate matrix format.

13. The apparatus of claim 1, wherein the shape of the elongated dielectric barrier members is selected from the group consisting of tubular, circular, square, rectangular, oval, polygonal, triangular, trapezoidal, rhombus and irregular.

14. The apparatus of claim 1, wherein the elongated dielectric barrier members are arranged in a non-planar configuration.

15. An apparatus for cleaning objects using plasma, comprising:
a plurality of elongated dielectric barrier members arranged adjacent each other in a microtiter plate matrix format;
a first set of electrodes arranged to be coupled to a voltage source at a first voltage, each electrode of the first set contained within, and extending substantially along the length of, a first set of the elongated dielectric barrier members; and
a second set of electrodes arranged to be coupled to a voltage source at a second voltage, each electrode of the second set contained within, and extending substantially along the length of, a second set of the elongated dielectric barrier members;
whereby, when the first and second voltages are applied, dielectric barrier discharges are created that form plasma between adjacent elongated dielectric barrier members for cleaning at least a portion of the objects.

16. The apparatus of claim 15, further comprising:
a first bus bar for electrically coupling the first set of electrodes to a voltage source having a first voltage; and
a second bus bar for electrically coupling the second set of electrodes to a voltage source having a second voltage.

17. A method for cleaning at least a portion of a plurality of objects, comprising:
providing a plurality of elongated dielectric barrier members having a first and second set of electrodes arranged therein;
introducing the objects proximate the elongated dielectric barrier members; and
generating a dielectric barrier discharge to form plasma between the elongated dielectric barrier members for cleaning at least a portion of each of the objects.

18. The method of claim 17, wherein the plasma comprises energetic and reactive particles selected from the group consisting of electrons, ions, excited and metastable species, and free radicals.

19. An apparatus for cleaning objects using plasma, comprising:
a plurality of elongated dielectric barrier plates arranged adjacent each other;
a first set of electrodes arranged to be coupled to a voltage source at a first voltage, each electrode of the first set contained within, and extending substantially along the length of, a first set of the elongated dielectric barrier plates; and
a second set of electrodes arranged to be coupled to a voltage source at a second voltage, each electrode of the second set contained within, and extending substantially along the length of, a second set of the elongated dielectric barrier plates;
whereby, when the first and second voltages are applied, dielectric barrier discharges are created to form plasma between adjacent elongated dielectric barrier plates to clean at least a portion of the objects.

20. The apparatus of claim 19, further comprising a voltage source electrically coupled to the first and second set of inner electrodes for producing a dielectric barrier discharge between the elongated dielectric barrier plates.
